(19) United States
(12) Patent Application Publication
(10) Pub. No.: US 2025/0082148 A1
(43) Pub. Date: Mar. 13, 2025

(54) AGGLOMERATION UNIT, SUCTION DEVICE AND METHOD FOR AGGLOMERATING VACUUMED MATERIAL

(71) Applicant: Hilti Aktiengesellschaft, Schaan (LI)

(72) Inventor: Stefan KRÄMER, Türkheim (DE)

(21) Appl. No.: 18/814,693

(22) Filed: Aug. 26, 2024

(30) Foreign Application Priority Data
Sep. 7, 2023 (EP) 23195904.0

(51) Int. Cl. A47L 9/10; A47L 9/12; B30B 9/28

(52) U.S. Cl. CPC A47L 9/108; A47L 9/102; A47L 9/12; B30B 9/28

(57) ABSTRACT

An agglomeration unit for agglomerating vacuumed material, wherein the agglomeration unit has an agglomeration chamber, wherein an agglomerator for agglomerating the vacuumed material is provided in the agglomeration chamber. The vacuumed material can be processed into a particularly stable agglomerate which can be disposed of safely and in an uncomplicated manner. A suction device which includes an agglomeration unit of this kind, and to a method for agglomerating vacuumed material by a suction device of this kind is also provided.

This claims priority to European Patent Application No. 23195904.0 filed on Sep. 7, 2023, which is hereby incorporated by reference herein.

The present invention relates to suction device such as industrial vacuum cleaners. In further aspects, the invention relates to a method for vacuumed material by means of a suction device of this kind.

### BACKGROUND OF THE INVENTION

In the construction industry, there are known suction devices, such as construction-grade or industrial vacuum cleaners which are used to suck up dust or particles that may be encountered on a construction site. This is done, on the one hand, to keep the construction site clean and, on the other hand, to protect the workers on the construction site from breathing in the dust or particles. In addition, such construction-grade or industrial vacuum cleaners can be used in craft enterprises in order, for example, to suck up dust in a workshop. Construction-grade vacuum cleaners generally have a dust collecting container to receive the vacuumed material sucked in.

### SUMMARY OF THE INVENTION

The vacuumed material to be sucked in can include substances or constituents which are categorized as hazardous or toxic to humans and therefore to workers on a construction site or in a craft enterprise. Such hazardous substances that are often encountered on construction sites or in craft enterprises include mineral dust, which may contain quartz for example, or hardwood dust particles. When vacuumed material is sucked in on a construction site or in a craft enterprise, such toxic or hazardous substances can enter the dust collecting container provided to receive the vacuumed material into the dust collecting container of the construction-grade vacuum cleaner. In this case, the appropriate and expert disposal of the contents of the dust collecting container may be somewhat difficult or pose particular challenges to the user of the construction-grade vacuum cleaner. This is because the toxic or hazardous substances may escape as the dust collecting container of the construction-grade vacuum cleaner is being emptied and may enter the environment and thus the airways of the workers on the construction site. To facilitate the disposal of such toxic or hazardous substances, dust bags may be inserted into the dust collecting container of the construction-grade vacuum cleaner to receive the vacuumed material, thus enabling the vacuumed material sucked in to be disposed of together with the toxic or hazardous substances in the dust bag. When the dust bag is full, the filled dust bag can be removed from the dust collecting container, and the dust bag and its contents can be disposed of. However, when such dust bags containing toxic or hazardous substances are placed in waste containers on the construction site, the dust bag may tear or be damaged in some other way. In this case, the toxic or hazardous substances may escape into the environment again and enter the airways of the workers on the construction site.

The prior art includes vacuum cleaners in which vacuumed material is compacted by forcing the air out of the vacuumed material located in the dust collecting container of the vacuum cleaner. For this purpose, rotating plastic slides can be used, for example. Such solutions are disclosed, for example, in EP 1 859 719 B1. However, the disadvantage with such compaction solutions is that the compaction product is often not particularly stable and can easily disintegrate. As a result, such compaction solutions are not suitable for delivering a satisfactory solution to the disposal of toxic substances in the construction industry.

In WO 2012 000 967 A1, a dust collecting system for a vacuum cleaner is disclosed, wherein two compression means for compressing the dust are arranged in the interior of the dust collecting container. A first compression means is designed as a roller system, while a second compression means is designed as a piston system. Among the elements used in the dust collecting system are rollers, and rolling vacuumed material generally leads to fine dust being thrown up. To this extent, a solution of the kind which is disclosed in WO 2012 000 967 A1 and which includes rolling the vacuumed material is incompatible with a technical solution for disposing of toxic substances in the construction industry, where there is the risk that toxic or hazardous dust particles will enter the airways of a human being.

It is an object of the present invention to overcome the above-described deficiencies and disadvantages of the prior art and to provide a technical solution for safe and easy disposal of vacuumed material, which may contain toxic or hazardous substances. The technical solution to be provided should, on the one hand, reliably prevent the toxic or hazardous substances from getting into people's airways. On the other hand, the technical solution to be provided should be so simple and user-friendly that it can be implemented by workers or craftsmen working, for example, on construction sites.

According to the invention, an agglomeration unit for agglomerating vacuumed material is provided, wherein the agglomeration unit has an agglomeration chamber, and wherein an agglomeration means for agglomerating the vacuumed material is provided in the agglomeration chamber.

Inasmuch as the vacuumed material is agglomerated in the context of the present invention, the invention is a departure from the prior art, in which the proposal is to compact the vacuumed material. This is because it has been found that vacuumed material which is compacted breaks down into its constituents again when very small forces, hardly more than a few newtons, are applied. In compacting, all that occurs essentially is that the air between the particles of the vacuumed material is forced out of the vacuumed material whereas, in agglomeration, solid pellets or briquettes which break down only when relatively high forces are applied are produced. As a result, the pellets or briquettes produced by agglomeration can be disposed of particularly easily, in particular even when there is a risk that they contain toxic substances. The pellets or briquettes can be separately packaged while still in the agglomeration unit or in a suction device comprising such an agglomeration unit, thus enabling these packaged pellets or briquettes to be removed and safely disposed of by a user of the agglomeration unit or the suction device. The particularly stable and non-frangible pellets or briquettes produced during agglomeration can also be removed from the agglomeration unit or the suction device and disposed of by the user without being packaged if the user has taken appropriate personal protection measures for such a task.

In the context of the invention, the pellets or briquettes produced by agglomeration can preferably be referred to as “agglomerate”. The term “agglomerate” can preferably be used for the agglomerated vacuumed material, i.e. for what was originally the preferably powdery vacuumed material which was compressed in the proposed agglomeration unit by an agglomeration process involving the application of relatively high pressures. Typical breaking forces that are required to break down the pellets or briquettes can be in a range greater than 10 newtons (N), for example.

The agglomeration process comprises the agglomeration of the vacuumed material by an agglomeration means. The agglomeration means can preferably be moved in the agglomeration chamber in order to agglomerate the vacuumed material. For the purposes of the invention, it is preferred that the agglomeration means is driven by means of a drive, wherein the drive can be designed as a hydraulic drive or as a pneumatic drive.

For the purposes of the invention, it is preferred that the agglomeration means is designed as a piston or as a spiral press, screw press and/or spindle press. At the same time, the agglomeration means can also serve as a transport or conveying means for transporting the vacuumed material that has been sucked in out of the dust collecting container into the agglomeration chamber. However, it is likewise preferred for the purposes of the invention that the agglomeration means and the transport means are separately formed devices. In the embodiment of the invention in which the agglomeration means and the transport means are separately formed devices, the agglomeration means can be designed as a piston or as a spiral press, screw press and/or spindle press, and the transport means can be designed as a spiral conveyor, screw conveyor and/or spindle conveyor.

The agglomeration means is preferably arranged movably in the agglomeration chamber, wherein it is possible, in particular, for the agglomeration means to move in a linear and/or rotating manner. In other words, the agglomeration means can be configured to perform a to-and-fro movement or forward and backward movement. In this embodiment, it is possible, in particular, for the agglomeration means to be designed as a piston or to comprise a piston. It is also possible, as a preferred option, for the agglomeration means to be designed to perform a rotary motion, that is to say to rotate in the agglomeration chamber. In this embodiment, it is possible, in particular, for the agglomeration means to be designed as a spiral press, screw press and/or spindle press or to comprise such a press.

The agglomeration means can preferably be configured to exert a force on the vacuumed material, wherein the vacuumed material can be agglomerated by the force applied. The forces which are used to agglomerate the vacuumed material in the context of the present invention can preferably be defined by a pressure with which the agglomeration means presses on the vacuumed material or with which the agglomeration means compresses the vacuumed material. During this agglomeration process, the material to be agglomerated is not just de-aerated, such that the air contained between the particles of the vacuumed material is pressed out of the material. Over and above that, the invention makes it possible for the vacuumed material, which was previously preferably predominantly in the form of powder, to be compressed into solid pellets or briquettes, making the agglomerate obtained particularly stable and resistant to being broken. Tests have shown that the pellets and briquettes produced by the agglomeration method proposed remain stable and do not crumble until forces of more than 10 newtons (N) are applied. The forces which are used to agglomerate the vacuumed material in the context of the present invention correspond to pressures of from 50 to 1000 megapascals (MPa), for example.

For the purposes of the invention, it is preferred that the agglomeration means has an effective surface, which is in contact with the vacuumed material during agglomeration, wherein a size of the effective surface is less than or equal to 200 cm². If the agglomeration means is designed as a piston, for example, the front piston surface, which is in contact with the vacuumed material during agglomeration, can be referred to as the effective surface. In particular, the piston can be in the form of a plunger, wherein the plunger surface of the piston forms the effective surface, which is in contact with the vacuumed material during agglomeration. This effective surface is preferably less than or equal to 200 cm². If the agglomeration means is designed as a screw press, the front region of the screw, which is in contact with the vacuumed material during agglomeration, can be referred to as the effective surface.

For the purposes of the invention, it is preferred for the agglomeration means to be driven by means of a drive. The drive of the agglomeration unit can preferably comprise a pump for a fluid, wherein it is possible to achieve a transmission ratio or pressure intensification by the drive having at least two effective surfaces of different sizes or area. For the purposes of the invention, it is preferred that a first effective surface of smaller size is driven by the pump, such that a force is transmitted by means of the fluid to a second effective surface of smaller size. The drive can be designed to be linear as a piston drive or to be rotary as a spiral press, screw press and/or spindle press, wherein the drive is preferably a component part of the agglomeration means of the agglomeration unit. The second effective surface of the drive can preferably correspond to the effective surface of the agglomeration means, which is in contact with the vacuumed material during agglomeration. In the context of the invention, the agglomeration means can preferably also be referred to as an “agglomerator”. Of course, the drive can also have more than two effective surfaces, thus making it possible to provide additional transmission stages and thus higher forces or pressures.

For the purposes of the invention, it is preferred that the drive is designed as a hydraulic drive or as a pneumatic drive. In the case of a hydraulic drive, the fluid mentioned above can be a hydraulic fluid such as oil, for example. In the case of a pneumatic drive, air or compressed air can be used as a fluid.

For the purposes of the invention, it is preferred that a force is exerted on the vacuumed material during agglomeration, wherein the force is determined by a pressure which is in a range of from 50 to 1000 megapascals (MPa), preferably in a range of from 100 to 750 megapascals and particularly preferably in a range of from 250 to 500 megapascals. By means of the said forces or pressures, it is advantageously possible to ensure that sufficiently high cohesion forces are achieved in the vacuumed material to be agglomerated to prevent the pellets or briquettes falling apart when touched and/or transported. In this way, a reliably stable and robust agglomeration result can be achieved, wherein the pellets or briquettes produced by agglomeration are particularly suitable for handling and easy to dispose of. By virtue of the easy handling and easier disposal and the resulting reduction in the effort involved in disposal, users may give a particularly positive welcome to the proposed agglomeration solution and be particularly happy to implement it.

For the purposes of the invention, it is preferred that the force which is exerted on the vacuumed material during agglomeration is exerted in a substantially constant manner. Tests have shown that a substantially constant application of force during the agglomeration process leads to a further improvement in the stability and resistance to breaking of the pellets and briquettes obtained. In particular, the pellets and briquettes produced by agglomeration with a substantially constant force are particularly uniform and, as a result, particularly resistant to spontaneous disintegration.

For the purposes of the invention, it is preferred that the agglomeration unit comprises means for adding a binder to the vacuumed material. To improve the stability and resistance to breaking of the pellets and briquettes obtained even further, a binder can be added to the vacuumed material before or during the agglomeration process, wherein the binder advantageously ensures particularly strong cohesion of the particles of vacuumed material in the pellets and briquettes produced by agglomeration. The binder can be solid or liquid and can be added to the vacuumed material as a mixture or as a pure substance. The binder may be water, for example. Furthermore, the binder can be selected from a group comprising wax, latex, starch, molasse, cement and/or polymers, without being restricted to these.

In a second aspect, the invention relates to a suction device having a proposed agglomeration unit. The terms, definitions and technical advantages introduced for the agglomeration unit preferably apply analogously to the suction device. The suction device can be designed as a construction-grade vacuum cleaner or as a central disposal station, for example. Construction-grade vacuum cleaners are appliances which are known per se and are used on construction sites or in craft enterprises, for example, to suck up dust or particles. This is done, on the one hand, to keep the construction site clean and, on the other hand, to protect the workers on the construction site from breathing in the dust or particles.

Construction-grade vacuum cleaners preferably have a motor, a turbine and a filtering device. The motor, the turbine and the filtering device of the construction-grade vacuum cleaner can be arranged in a vacuum cleaner head, wherein the vacuum cleaner head preferably forms the upper part of the construction-grade vacuum cleaner. The motor of the construction-grade vacuum cleaner is preferably configured to drive the turbine of the construction-grade vacuum cleaner, wherein the turbine of the construction-grade vacuum cleaner is preferably configured to generate a vacuum in the interior of the construction-grade vacuum cleaner. The vacuum is preferably used to suck in the vacuumed material. The sucking in of the vacuumed material is preferably accomplished by virtue of the fact that the vacuum generates an (inward) suction flow by means of which the vacuumed material can be sucked in. For this purpose, the suction device can be connected to a suction hose in order to transfer the vacuum to a suction location or to carry the suction flow. During the operation of the suction device, the suction flow includes a mixture of air and vacuumed material. In other words, dust and particles are contained in the air forming the suction flow. This mixture of air and vacuumed material can enter the interior of the suction device via the suction hose and openings in the suction device. In the case of conventional construction-grade vacuum cleaners that are known from the prior art, the vacuumed material separates from the suction flow and collects in the dust collecting container. The dust collecting container preferably forms the bottom part of the construction-grade vacuum cleaner.

The suction device can also be designed as a central disposal station. Such a central disposal station can be used, for example, on a construction site to receive and collect the contents of various suction appliances or the dust collecting containers thereof until emptying or expert disposal of the contents of the central disposal station can be performed. For example, a user of a suction device can come to the central disposal station with the suction device in order to empty the dust container of the suction device. For this purpose, the dust collecting container of the suction device can be connected fluidically to the central disposal station, thus enabling the contents of the dust collecting container of the suction device to be transferred to the central disposal station. For example, the contents of the dust collecting container of the suction device can be extracted or sucked out by the central disposal station. For this purpose, the central disposal station can comprise a motor and a turbine, wherein the turbine is configured to generate a vacuum and thereby a suction flow. The central disposal station can also be configured for a cover to be opened and for the filled dust bag from the suction devices to be placed in the collecting chamber of the central disposal station. The suction device may also be, for example, a suction box of the kind used, for example, in the region of hammer drills. Such suction boxes can be secured directly on the hammer drill-preferably on the underside thereof-in order to receive the dust generated during work with the hammer drill. For example, suction robots or backpack cleaners, i.e. vacuum cleaners carried on the back, can also be suction devices in the sense according to the invention.

In the context of the present invention, it is now preferred that the suction device has at least one separator for separating particles from the vacuumed material. One or more separation devices can preferably be provided to separate particles of different sizes from the vacuumed material or from the suction flow at different locations within the suction device. For example, particles with a relatively large diameter can be separated from the suction flow in a first separation stage. A first separator or a first separation device, which is used to carry out the first separation stage, can be designed as an inertia-based separator, for example. For the purposes of the invention, it is preferred that the particles which are separated from the suction flow in this first separation stage are not included in the agglomeration process. Accordingly, they are collected in a separate dust collecting container for disposal at a later stage.

The inertia-based separator is preferably configured to separate particles with a relatively large diameter from the suction flow and from particles with a smaller diameter. For the purposes of the invention, the diameter of the particles with the relatively large diameter is preferably referred to as the “first diameter” or “first particle diameter”, while, for the purposes of the invention, the diameter of the particles with the smaller particle diameter are preferably referred to as the “second diameter” or “second particle diameter”. The particles with a relatively large diameter are preferably those particles whose size makes them non-respirable. For the purposes of the invention, this preferably means that these particles with the relatively large diameter do not penetrate deep into the lung when breathed in by a human being. As a result, such non-respirable particles are significantly less dangerous for humans since they generally cause almost no damage or little damage in comparison with respirable particles. Thus, for the purposes of the invention, it is preferred that non-respirable particles are separated from the suction flow in a first separation stage. In contrast, respirable particles can penetrate deep into the human lung and can in this way damage the lung.

Inertia-based separators can preferably also be referred to as inertial separators, wherein, for example, cyclones or baffle plates can be used as inertia-based separators. In the case of cyclones as an example of centrifugal separators, rotation is imparted to a flow or the suction flow containing particles of different sizes, wherein heavy particles, which preferably have a larger first diameter, are separated out by the centrifugal force. The centrifugal force has less of an effect on light particles with a smaller second diameter, with the result that such small, light particles remain in the flow. In the case of a baffle plate, a flow or the suction flow can be deflected, wherein heavy particles, which preferably have a larger first diameter, cannot follow the deflection quickly enough or at all on account of their inertia, as a result of which they are separated out. Light particles with a smaller second diameter are better able to follow the deflection, with the result that such small, light particles advantageously remain in the flow. For the purposes of the invention, it is preferred that the small, light particles which are not separated from the suction flow in this first separation stage are agglomerated in the agglomeration unit or in the agglomeration chamber.

For the purposes of the invention, it is preferred that the suction device has a dust collecting container for receiving the vacuumed material in addition to the agglomeration chamber. For the purposes of the invention, this preferably means that the agglomeration of the vacuumed material does not take place in the dust collecting container of a conventional vacuum cleaner but in a separate agglomeration chamber, which is a component part of the proposed agglomeration unit. For agglomeration, relatively high forces are required, which are transferred by an agglomeration means to the vacuumed material to be agglomerated. These relatively high forces preferably correspond to pressures in a range of between 50 and 1000 MPa. However, the agglomeration process cannot be carried out in a conventional dust collecting container on account of these high forces, and therefore a separate agglomeration chamber is provided in the proposed agglomeration unit. The separate agglomeration chamber is preferably significantly smaller than the dust collecting container of the suction device. As a result, the forces or pressures which are required for agglomerating the vacuumed material can be handled particularly well. In the case of larger containers, e.g. the dust collecting containers of conventional construction-grade or industrial vacuum cleaners, very high forces would be required to agglomerate the vacuumed material in the manner desired on account of the large cross section of these containers.

In the dust collecting container of the suction device, it is possible, in particular, to collect the relatively large-diameter non-respirable particles, which can preferably be separated from the suction flow in the first separation stage.

In another aspect, the invention relates to agglomeration of vacuumed material using a proposed suction device. The terms, definitions and technical advantages introduced for the suction device and the agglomeration unit preferably apply analogously to the agglomeration method. The agglomeration method is characterized by the following method steps:
a) sucking in the vacuumed material by means of a suction flow, which takes up the vacuumed material,
b) transporting the vacuumed material into the agglomeration chamber of the agglomeration unit of the suction device,
c) agglomerating the vacuumed material by means of an agglomeration means.

It is preferably and especially particles with a relatively small second diameter that can be agglomerated by means of the proposed method. As the agglomerate, it is preferably solid pellets or briquettes that are obtained, which advantageously break down or crumble only under “breaking forces” greater than 10 newtons. The particles with the relatively small second diameter are preferably filtered out of the suction flow before agglomeration, and are then agglomerated. A filtering device or filter, for example, can be used for this purpose. The particles with the relatively small second diameter can preferably be those referred to as respirable particles, which are particularly harmful to humans or the human lung. In other words, for the purposes of the invention, it is therefore preferred that these respirable particles can be filtered out of the suction flow—e.g. by means of a filtering device or filter. Respirable or alveolar particles have a diameter in a range of 5-10 micrometres (μm), for example. After being filtered out, these small respirable particles can be transported into the agglomeration chamber of the agglomeration unit of the suction device by means of a transport device. The transport device can be designed as a vibration motor or as a spiral conveyor, screw conveyor and/or spindle conveyor, for example.

For the purposes of the invention, it is preferred that another part of the vacuumed material is separated from the suction flow by means of a separator before agglomeration, ensuring that this other part of the vacuumed material is not included in the agglomeration process. For the purposes of the invention, it is preferred that it is especially particles with a relatively large first diameter that are separated from the suction flow. For the purposes of the invention, it is very particularly preferred that particles with a diameter of more than 1 millimetre (mm) are separated from the suction flow so as to remain in the dust collecting container of the suction device, while the smaller particles are filtered out of the suction flow so as to be fed to the agglomeration process. It has been found that, in particular, particles with a diameter of less than 1 mm are particularly well suited to agglomeration because they form a compact agglomerate which breaks down again only under breaking forces in a range of 10 N, for example.

For the purposes of the invention, it is preferred that it is particles with a relatively small diameter that are separated from the suction flow. The respirable particles can preferably be separated from the suction flow by means of a filter before they are transported into the agglomeration chamber for agglomeration. For the purposes of the invention, it is particularly preferred that it is especially the alveolar particles with a diameter greater than 5-10 micrometres (μm) which are agglomerated. In the context of the present invention, the two terms “alveolar” and “respirable” are preferably used as synonyms.

Further advantages can be found in the following description of the figure. The figure, the description and the claims contain numerous features in combination. The person skilled in the art will also expediently consider the features individually and combine them into further expedient combinations.

### BRIEF DESCRIPTION OF THE DRAWINGS

Identical and similar components are denoted by the same reference signs in the figure,

where:

FIG. 1 shows a view of a preferred embodiment of the suction device according to the present invention.

### DETAILED DESCRIPTION

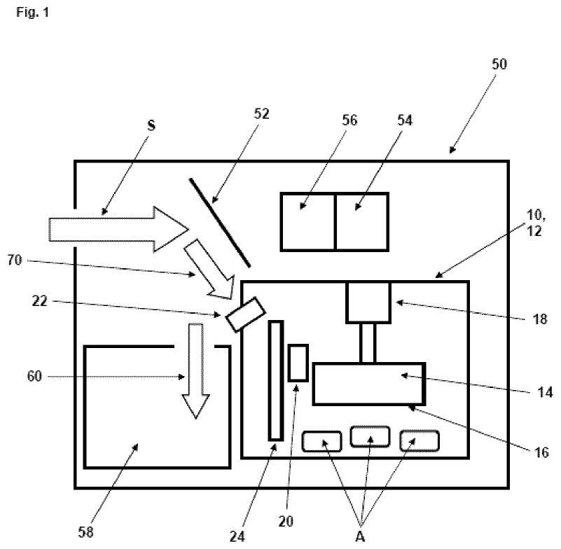

FIG. 1 shows a preferred embodiment of a suction device 50. The suction device 50 has a dust collecting container 58 for receiving vacuumed material S, as well as a motor 54 and a turbine 56 for generating a vacuum and a suction flow for sucking in the vacuumed material S. In addition, the suction device 50 has a separation device 52. When a suction flow laden with vacuumed material S is sucked into the suction device 50, particles 60 with a relatively large diameter can be separated from the suction flow or the vacuumed material S by means of the separation device 52. The particles 60 with the relatively large diameter are preferably non-respirable particles, which are not very hazardous to humans and their airways according to the current state of knowledge. These non-respirable particles 60 can preferably be separated from the suction flow or the vacuumed material S by the separation device 52 of the suction device 50. The separation device 52 illustrated in FIG. 1 is designed as a baffle plate, for example. However, it is also possible to use cyclones or other inertia-based separation devices, inertial or centrifugal separators as a separation device 52 in the suction device 50. The non-respirable particles 60 which are separated from the suction flow by the separation device 52 in a first separation stage can be collected in the dust collecting container 58 of the suction device 50 and disposed of later in an uncomplicated way since they are virtually harmless to humans.

Particles 70 with a relatively small diameter of less than 10 μm are regarded as respirable; they can penetrate deep into the human lung and airways and thus represent a hazard to human health. The respirable particles 70 remain in the suction flow after the first separation stage and, in the case of the embodiment of the suction device 50 illustrated in FIG. 1, enter the agglomeration unit 10 via a filter 22. In other words, the filtering device 22 of the suction device 50 is configured to filter the respirable particles 70 out of the suction flow in a second separation stage, such that it is, in particular, the respirable particles 70 to be agglomerated that enter the agglomeration unit 10 in order to be agglomerated in the agglomeration chamber 12 of the agglomeration unit 10.

The agglomeration unit 10 has an agglomeration chamber 12, in which an agglomeration means 14 is arranged in a movable manner. The agglomeration means 14 can be designed as a piston, for example. The front plunger surface of the piston 14 can serve as an effective surface 16, wherein this effective surface 16 comes into contact during the agglomeration process with the vacuumed material S to be agglomerated. At this point in time, the vacuumed material S to be agglomerated preferably consists almost exclusively of respirable particles 70. The agglomeration means 12 can be driven by a drive 18, wherein the drive 18 can be designed as a hydraulic or pneumatic drive. In the exemplary embodiment of the invention which is illustrated in FIG. 1, the agglomeration means 12 can perform a linear up-and-down motion, for example. Agglomerates A, i.e. pellets or briquettes as the product of the agglomeration process, are depicted in the lower region of the agglomeration chamber 14. The agglomeration unit 10 can furthermore have a binder supply means 20 for adding binder to the vacuumed material S to be agglomerated. By means of the binder, it is possible to further improve the cohesion between the particles to be agglomerated. In addition, transport means 24 can be provided in the agglomeration unit 10 in order to bring the respirable particles 70 into the effective region of the agglomeration means 12.

### LIST OF REFERENCE SIGNS

10 Agglomeration unit
12 Agglomeration chamber
14 Agglomeration means
16 Effective surface
18 Drive
20 Means for adding a binder
22 Filter
24 Transport device
50 Suction device
52 Separator
54 Motor of the suction device
56 Turbine of the suction device
58 Dust collecting container of the suction device
60 Particles with a relatively large diameter
70 Particles with a relatively small diameter
A Agglomerate
S Vacuumed material

What is claimed is:

1. Agglomeration unit for agglomerating vacuumed material, the agglomeration unit comprising:
an agglomeration chamber; and
an agglomerator for agglomerating the vacuumed material in the agglomeration chamber.

2. The agglomeration unit as recited in claim 1 wherein the agglomerator includes a piston, spiral press, screw press or spindle press.

3. The agglomeration unit as recited in claim 1 wherein the agglomerator has an effective surface in contact with the vacuumed material during agglomeration, a size of the effective surface being less than or equal to 200 cm².

4. The agglomeration unit as recited in claim 1 further comprising a drive driving the the agglomerator.

5. The agglomeration unit as recited in claim 4 wherein the drive is a hydraulic drive or as a pneumatic drive.

6. The agglomeration unit as recited in claim 1 wherein a force is exerted on the vacuumed material S during agglomeration, wherein the force is determined by a pressure in a range of 50 to 1000 megapascals.

7. The agglomeration unit as recited in claim 1 wherein a force is exerted on the vacuumed material S during agglomeration, wherein the force is determined by a pressure in a range of 50 to 1000 megapascals.

8. The agglomeration unit as recited in claim 1 wherein a force is exerted on the vacuumed material S during agglomeration, wherein the force is determined by a pressure in a range of 250 to 500 megapascals.

9. The agglomeration unit as recited in claim 1 wherein a force exerted on the vacuumed material S during agglomeration is exerted in a substantially constant manner.

10. The agglomeration unit as recited in claim 1 further comprising a binder supply for adding a binder to the vacuumed material.

11. A suction device comprising: the agglomeration unit as recited in claim 1, the suction device being designed as a construction-grade vacuum cleaner or as a central disposal station.

12. The suction device as recited in claim 11 further comprising at least one separator for separating particles from the vacuumed material.

13. The suction device as recited in claim 11 further comprising a dust collecting container for receiving the vacuumed material in addition to the agglomeration chamber.

14. A method for agglomerating vacuumed material by the suction device as recited in claim 11, the method comprising the steps of:
a) sucking in the vacuumed material via a suction flow,
b) transporting the vacuumed material into the agglomeration chamber of the agglomeration unit of the suction device, and
c) agglomerating the vacuumed material via the agglomerator.

15. The method as recited in claim 14 wherein particles with a relatively large diameter are separated from the suction flow, ensuring that the particles with the relatively large diameter are not included in the agglomeration process.

16. The method as recited in claim 14 wherein the particles with the relatively large diameter are collected in a dust collecting container of the suction device.

17. The method as recited in claim 14 wherein particles with a relatively small diameter are separated from the suction flow via a filter before the particles with the relatively small diameter are transported into the agglomeration chamber for agglomeration.
